(19) United States
(12) Patent Application Publication
(10) Pub. No.: US 2025/0279105 A1
(43) Pub. Date: Sep. 4, 2025

(54) Accelerated Audio Separation and Classification for On-Device Machine-Learned Systems

(71) Applicant: Google LLC, Mountain View, CA (US)

(72) Inventors: Cheng Yang, Sunnyvale, CA (US); Xing Li, Redmond, WA (US); Pascal Tom Getreuer, San Francisco, CA (US); Jianing Wei, Cupertino, CA (US)

(21) Appl. No.: 19/068,764

(22) Filed: Mar. 3, 2025

Related U.S. Application Data
(60) Provisional application No. 63/560,491, filed on Mar. 1, 2024.

(51) Int. Cl. G10L 19/008; G10L 21/0272; H04N 19/44

(52) U.S. Cl. CPC G10L 19/008; G10L 21/0272; H04N 19/44

(57) ABSTRACT

Aspects of the disclosed technology include computer-implemented systems and methods for automatically separating sounds associated with different sources in media such as video. More particularly, a machine-learned system is configured to separate sounds in media and provide an interface for users to easily manipulate the separated sounds during playback of the media. The system can obtain media, provide decoded audio from the media to a machine-learned audio separation model, generate a plurality of separated sound components from the decoded audio using the machine-learned audio separation model, provide decoded video from the media and the plurality of separated sound components to a machine-learned audio classification model, and generate a class label for each of the plurality of separated sound components using the machine-learned audio classification model.

### PRIORITY CLAIM

This application is based upon and claims the right of priority to U.S. Provisional Application No. 63/560,491, filed on Mar. 1, 2024, the disclosure of which is hereby incorporated by reference herein in its entirety for all purposes.

### FIELD

The present disclosure relates generally to machine learning processes and machine-learned devices and systems. More particularly, the present disclosure relates to on-device machine-learned implementations for separation of audio components from different sources in media.

### BACKGROUND

Artificial intelligence systems increasingly include machine-learned models which have the capability to provide a wide range of new product experiences. As these models become more prevalent, so too has the need for efficient implementations of these models for downstream tasks. For instance, sound separation models may be able to separate sounds from different sources within a single media input. In many instances, these models are large and require a large amount of computing resources including processing and storage capacity. Additionally, these models are often hosted on large server systems that include large compute capacity. Implementations of these models on smaller compute devices such as user devices including smartphones, watches, and the like may be impractical or lead to less than satisfactory user experiences due to long processing times.

Accordingly, there remains a need for machine-learned systems that can be implemented on computing systems such as mobile devices.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method implemented by one or more processors that includes obtaining media including audio and video, providing decoded audio from the media to a machine-learned audio separation model, generating a plurality of separated sound components from the decoded audio using the machine-learned audio separation model, providing decoded video from the media and the plurality of separated sound components to a machine-learned audio classification model, and generating a class label for each of the plurality of separated sound components using the machine-learned audio classification model.

Another example aspect of the present disclosure is directed to a system including one or more processors and one or more computer-readable storage media that store instructions that, when executed by the one or more processors, cause the one or more processors to perform operations. The operations include obtaining media including audio and video, providing decoded audio from the media to a machine-learned audio separation model, generating a plurality of separated sound components from the decoded audio using the machine-learned audio separation model, providing decoded video from the media and the plurality of separated sound components to a machine-learned audio classification model, and generating a class label for each of the plurality of separated sound components using the machine-learned audio classification model.

Yet another example aspect of the present disclosure is directed to a computer-implemented method implemented by one or more processors. The method includes obtaining media including a plurality of frames of audio and video, providing decoded audio from the media to a machine-learned audio separation model, generating a plurality of separated sound components from the decoded audio using the machine-learned audio separation model, performing keyframe-only decoding of the media to generate decoded video corresponding to less than all of the plurality of frames of video from the media, providing the decoded video and the plurality of separated sound components to a machine-learned audio classification model, generating an audio class label for each of the plurality of separated sound components using the machine-learned audio separation model, and generating a graphical user interface including the audio class label and a user interface element for each of the plurality of separated sound components, wherein the user interface element enables user modification of a corresponding separated sound component.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a machine-learned system for separating sounds from a media input and providing an interface for manipulating distinct sounds in the media input according to example embodiments of the present disclosure;

FIG. 2 is a diagram depicting an example sound input as a 2D image of time vs. frequency according to example embodiments of the present disclosure;

FIG. 3 is a block diagram of an example computing environment including a machine-learned model that is configured to separate an audio input into distinct audio outputs associated with different sound sources according to example embodiments of the present disclosure;

FIG. 4 is a diagram depicting masks predicted for the short-time Fourier transform (STFT) of FIG. 2 according to example embodiments of the present disclosure;

FIGS. 5A-5C are diagrams depicting separated audio waveforms corresponding to different sound sources according to example embodiments of the present disclosure;

FIG. 6 depicts an example user interface for playback of video with separated audio components according to example embodiments of the present disclosure;

FIG. 7 depicts an example user interface and user interaction with the user interface according to example embodiments of the present disclosure;

FIG. 8 is a block diagram depicting an example computing environment including a computing pipeline framework graph according to example embodiments of the present disclosure;

FIG. 9 is a flow chart diagram illustrating an example method for separating and classifying sounds using a machine-learned audio separation model and audio classification model according to example embodiments of the present disclosure;

FIG. 10 is a flow chart diagram illustrating an example method for training a machine-learned model according to example embodiments of the present disclosure;

FIG. 11 is a block diagram of an example processing flow for using machine-learned model(s) to process input(s) to generate output(s) according to example embodiments of the present disclosure;

FIG. 12 is a block diagram of an inference system for operating one or more machine-learned model(s) to perform inference according to example embodiments of the present disclosure;

FIG. 13A is a block diagram of an example networked computing system according to example embodiments of the present disclosure; and

FIG. 13B is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to machine-learned systems and methods for automatically separating sounds associated with different sources in media such as video. More particularly, a machine-learned system is configured to separate sounds in media and provide an interface for users to easily manipulate the separated sounds during playback of the media. For example, the system can access a video input, identify and separate sounds within the video based on source, and provide a user interface to enable a user to reduce, remove, or otherwise manipulate particular sounds. By way of example, the system can obtain a video of a person speaking and automatically separate the audio into separated sound components including user speech, howling winds, and noisy crowds, for example. The user can access the user interface to reduce or eliminate undesirable sounds, for example.

More particularly, a machine-learned system is described that utilizes a machine-learned audio-visual separation model to automatically separate sounds that originate from different sources in video and a machine-learned classification model to generate audio class labels for each different source. The machine-learned system includes a computing pipeline that is configured to execute efficiently on devices with lower compute capacity such as mobile devices (e.g., smartphones, smartwatches, and the like). A computing pipeline in accordance with example embodiments of the present disclosure provides an optimized solution that can achieve fast end-to-end on-device processing latency without noticeable model quality degradation. The computing pipeline can include a machine-learned sound separation model and a machine-learned classification model which can be executed by a mobile device to meet strict end-end on-device product requirements, while automatically separating sound sources in media inputs such as video.

In accordance with example embodiments of the present disclosure, a machine-learned sound separation system is implemented using a computing pipeline including a sound separation model configured to separate sounds from media according to their sources and a classification model configured to classify each of the different sound sources into one or more audio or source classes. The system can leverage both audio and video signals from a media input to separate sounds and generate class labels for each separated sound. The class labels can indicate a predicted source of each separated sound.

According to an example implementation, the computing pipeline can implement global mode processing that is global in time where all of the audio data from a media input is first decoded and passed to the sound separation model. With processing that is global in time, the full media can be processed all at once as one large buffer, for example. By contrast, processing that is streaming in time processes the media incrementally over a sequence of small buffers. While this can be more memory efficient, it may limit operations to those that are local to the current buffer or may limit the reuse of information from previously seen buffers (causal processing). In other examples, hybrid or multistage elaborations of the processing approaches can be used. The sound separation model can generate an audio output for each separated sound from the media input. Each separated sound can correspond to a different sound source.

In addition to sound separation, the system can use audio-visual analysis, considering both sound and the video frames, to predict source attributes that will assist in effective editing. For each separated sound, a machine-learned classification model can classify the type or source of the sound (speech, music, wind, etc.). In some examples, the classification model can predict whether the sound is a desirable subject to be captured versus an undesirable distractor to be suppressed. Video can be helpful to make an audio-visual correspondence so that the model can both “see and hear” the sound source to infer additional information. The video data from the media input can be decoded and passed to the classification model along with each separated sound. The classification model can generate a class label for each separated sound indicative of the predicted source of the sound.

According to an example implementation, the computing pipeline can generate data for a graphical user interface including a class label and a user interface element corresponding to each separated sound component. The user interface element can be selectable, modifiable, or otherwise capable of receiving user input to modify the corresponding separated sound. In example embodiments, the video signal from the media input can be played back in the user interface. The separated sounds can be played back together or as a single audio output based on the user input to the user interface. By way of example, the system can include a remixer that receives the separated sounds and class labels and generates the user interface including the class labels and initial values for the user interface elements. For example, each sound source can include an adjustable slider user interface element. The system can provide initial slider values for the slider user interface elements to control the level, volume, or loudness of the corresponding sound. A playback mixer can receive the user slider values from the graphical user interface. The playback mixer can modify the separated sounds, such as by adjusting the level or volume of the separated sounds, and generate an output audio signal that includes a mix of the separated sounds based on the user slider values.

According to an example implementation, a computing pipeline can be implemented using a graph-based execution framework to provide a machine-learned sound separation and classification system. The computing pipeline can implement automatic sound separation, classification, and sound manipulation during playback of media inputs. By way of example, the computing pipeline can be implemented as a graph with execution nodes using a computing pipeline framework such as MediaPipe provided by Google, Inc. Data marshaling between frameworks can be avoided in many instances using optimization choices that include implementing core operations in a native side or language of the pipeline framework. For example, audio and video decoding can be performed in the managed memory (C++) to avoid data marshaling from unmanaged memory (e.g., Java) to a managed memory via an interface (e.g., Java Native Interface (JNI)). As another example, the separated sounds can be stored by keeping separated audio data saving flow in the native language to avoid data marshaling from the native language to another language (e.g., from a native language to Java via JNI). Data exchange between languages (e.g., from Java and native) can be minimized during preprocessing as much as possible.

According to an example implementation, the computing pipeline can provide execution parallelism since the pipeline utilizes both audio and video signals from a media input. The computing pipeline framework can maximize the graph concurrency of the framework with desired thread pool size and priority.

Audio processing accelerations are provided in example embodiments. In some frameworks such as MediaPipe, audio data can be passed via Eigen: Matrix. Various improvements are provided to avoid unnecessary memory copies to both reduce memory usage and provide fast data processing. In one example, packets can be passed by shared pointers and the system can avoid copying by using methods such as “ConsumeOrCopy” instead of “Copy” to the extent possible. As another example, the system can use Eigen::Block and Eigen::Map objects, which view the data instead of copying. This can be useful in processing calculators. For example, TimeSeriesFramerCalculator can be used heavily in preprocess and postprocess. This method can originally construct a distinct Matrix object for every input sample and can be updated to group each input packet's content into one Matrix. In an example implementation, the use of TimeSeriesFramerCalculator can provide a 20× increase in speed. As another example, the system can use a SoundSeparationApplyMask Calculator. The system can also avoid duplicated processes and initializations. For example, a method ResampleTimeSeriesQResamplerCalculator can process multichannel signals with one resampler instead of one resampler per track.

Image processing accelerations are provided in example embodiments. The computing pipeline can utilize an Eigen::Tensor API when preparing image tensor inputs for the classification model. This technique can include efficiently stacking the image frames which can be useful for different input sync set duration for the classification model. When keyframe decoding is used, downsample and other downstream operations can be applied after keyframe decoding to avoid unnecessary processing on skipped frames. In some examples, image processing is performed entirely on the GPU of the device to prevent GPU-CPU memory transfers. In this manner, a method such as VideoDecoderCalculator can decode the media input video into GPU buffers instead of CPU image frames. In some examples, the image can be downsized on the GPU, for example, by using an efficient and high quality calculator such as GIAntialiasingDownSampleCalculator. An image to tensor calculator such as ImageToTensorCalculator can be configured such that the input stream (e.g., input_stream) is set to GPU (e.g., IMAGE_GPU).

According to example implementation, audio processing can be prioritized to execute as fast as possible. For example, the computing pipeline can be managed by at least one executor, which is a thread pool with a number of threads based on the system's capabilities. Some devices may have a default number of threads. The default number of threads can be used in some examples as the execution framework (e.g., the executor) can automatically schedule node operations based on thread availability. Recognizing that audio decoding is critical to the computing pipeline, audio decoding can be prioritized with settings to prioritize audio decoding to be as fast as possible (e.g., require_processor_performance: HIGH). To prevent thread switching by the system, audio decoding can fixate running on one thread (e.g., num_threads: 1). The priority can be set very high, for example, near to or the same as UI thread priority (e.g., nice_priority_level: −10). These settings can ensure that audio data is decoded as the first task and as fast as possible, while the video decoding can happen concurrently with sound separation inference and subsequent processing.

In accordance with example embodiments, a keyframe only decoding method is implemented to decode video from the media input. The system can decrease the video decoding time by decoding key frames only, rather than decoding all frames until a particular frame is reached. Decoding keyframes is faster than decoding interframes whose decoding is based on deltas relative to neighboring frames. In accordance with example embodiments, a seek operation can be utilized with keyframe decoding to further decrease video decoding time. A seek operation can be used to locate a keyframe nearest to a required video frame, and then decoding of the nearest keyframe can be performed. The seek operation and keyframe decoding together take less time than decoding all of the frames from the beginning until reaching a particular frame. In some examples, a particular decoding rate can be selected and a nearest neighbor interpolation method used. For example, if one frame-per-second (1 FPS) is used for sound separation and classification, the system can use the nearest neighbor interpolation method to ensure the keyframe rate matches the expected 1 FPS.

According to an example implementation, the full content of the audio component of a media input can be used while only a subset of frames of the video component can be used. For example, the computing pipeline can utilize the full stream content from a media input and a reduced frame rate from the video component. Traditionally, while decoding video with a “keyframe” decoding technique, decoding the video is performed by the video's “Group of Pictures (GoP)” length (e.g., the distance between the two keyframes, measured in the number of frames, or the amount of time between keyframes). This length may be determined by the encoder that writes the video. Because media inputs such as video can come from different devices, the system can be configured to handle different GoP videos. For example, if the required frame rate is 1 Hz and a video has a DP length greater than one second, the system can duplicate the nearest keyframe to avoid decoding P frames which can introduce delays. Using the duplicated frame can result in very low quality degradation compared to decoding the actual frame.

According to an example implementation, batch decoding can be used to avoid the potential that the computing pipeline waits for a pipeline scheduler's next process. For typical media playback, decoding is rate limited to avoid throttling the rendering. For audio separation and classification, however, it can be desirable to decode as fast as possible. In the computing pipeline framework for source nodes (e.g., decoders are source nodes), there may be an event loop that drives a “Process( )” call which is at a certain frequency. Usually, when each Process( ) call is invoked a method will send out the data that has been decoded since the last call. In accordance with example embodiments of the present disclosure, batch decoding can be used to send out all decoded content from one Process( ) call to avoid the potential of the scheduler waiting on the next Process( ) In some examples, the system does not set a max buffer size for decoding to limit each output size to maximize decoding speed.

According to an example implementation, a machine-learned sound separation model can be configured to take audio content as an input and generate separated sound outputs. The separated sounds can be generated as individual separated audio components in example embodiments. For example, each separated sound associated with a distinct source can be generated as a separate audio file. The machine-learned sound separation model can be executed by a graphical processing unit (GPU) in an example embodiment, although other processing units such as a tensor processing unit (TPU) or central processing unit (CPU) may be used to execute the sound separation model. In an example embodiment, the tensor input size can be set to allow entire Short-Time Fourier Transform (STFT) frames of the audio from the media input to be processed at one time. In another example embodiment, the model can be compiled and run normally on-device with a CPU delegate of XNNPack (XNNPACK is a highly optimized solution for neural network inference on ARM, x86, WebAssembly, and RISC-V platforms). With a GPU delegate default implementation, a few operators may not be implemented. OpenCL can be used in place of an OpenGL implementation to allow all operators to be implemented, but there may not be a speed advantage of the GPU in such a case. A cached mechanism can be implemented for fast non-initial inference and to use InferenceRunner only. In another example,

FAST SINGLE ANSWER can be used to improve performance which may bring in a lower first-time caching.

According to an example implementation, a machine-learned classification model can be configured to generate class labels that are indicative of a source of each separated sound from the input media. The machine-learned classification model can be executed by a tensor processing unit (TPU) in an example embodiment, although other processors such as a graphical processor unit (GPU) or central processing unit (CPU) may be used to execute the classification model. When setting up the TPU delegate, the inference priority can be set to match the priority of existing features in the pipeline to reduce latency.

System and methods in accordance with example embodiments of the present disclosure provide a number of technical effects and benefits. More particularly, the systems and methods include a machine-learned audio separation and classification system that can operate universally on audio regardless of class. Traditional work on sound separation has focused on individual sound classes, such as separating speech from non-speech. According to example embodiments of the present disclosure, a sound separation and classification framework is provided that can effectively separate arbitrary sounds, regardless of class. By designing a universal sound separation and classification system, there are many interesting non-speech sounds that can be identified for keeping or suppression independently of other non-speech sounds.

Systems and methods in accordance with example embodiments provide an on-device machine-learned sound separation solution that is capable of efficient execution by devices having lower compute capacities such as mobile phones. Traditional streaming mode processes for example, process audio in a streaming mode. Such techniques require video frames at a high frame rate for visual classification. The separated sounds can change over time making it difficult to merge the sounds that come from the same source into a single track. Such issues can cause processing latencies and negative user experiences. For visual processing, the video frames are decoded first and then fed to the classifier at the high frame rate. Because the decoding step can take a large amount of time, the issue can cause processing latencies and negative user experiences.

Systems and methods in accordance with embodiments of the present disclosure enable fast and robust operation on mobile devices. Processing can be performed on-device to minimize processing time and to preserve the user privacy. Inferences from the models can be run on-device with improved system health evaluation including memory and battery consumption. The end-to-end computing pipeline includes media decoding and can run quickly and efficiently on-device to ensure a good user experience. Moreover, the latency and compute improvement methods can be performed with no degradation of model quality.

A computing pipeline framework is provided that processes most data in native code. Algorithms and media processing can be moved into native code to improve performance by avoiding data marshaling. Additionally, customized media decoding is provided to use high efficiency key frame decoding and batch processing. An appropriate mixed set of model inference delegates is provided to fully utilize the platform capabilities. By way of example, GPU inference instead of CPU inference for sound separation can provides substantial increases in inference speed (e.g., 5×). TPU inference for sound classification can provide substantial increases in inference speed (e.g., 10×).

The computing pipeline utilizes execution parallelism to further improve on-device performance. Because the ML computing pipeline operates on both audio and video signals, the pipeline parallelizes components where possible. This benefit brought by the nature of implementing such a pipeline using a graph framework can maximize the graph concurrency with desired thread pool size and priority. Audio and video processing units can be accelerated by using efficient operations.

Although a number of examples of tasks which may be performed by the core model and/or a downstream application are provided here, it will be understood that this is not exhaustive, and that the core model and/or the downstream applications can be configured to perform any suitable task.

With reference now to the Figures, example embodiments of the present disclosure will be discussed in further detail.

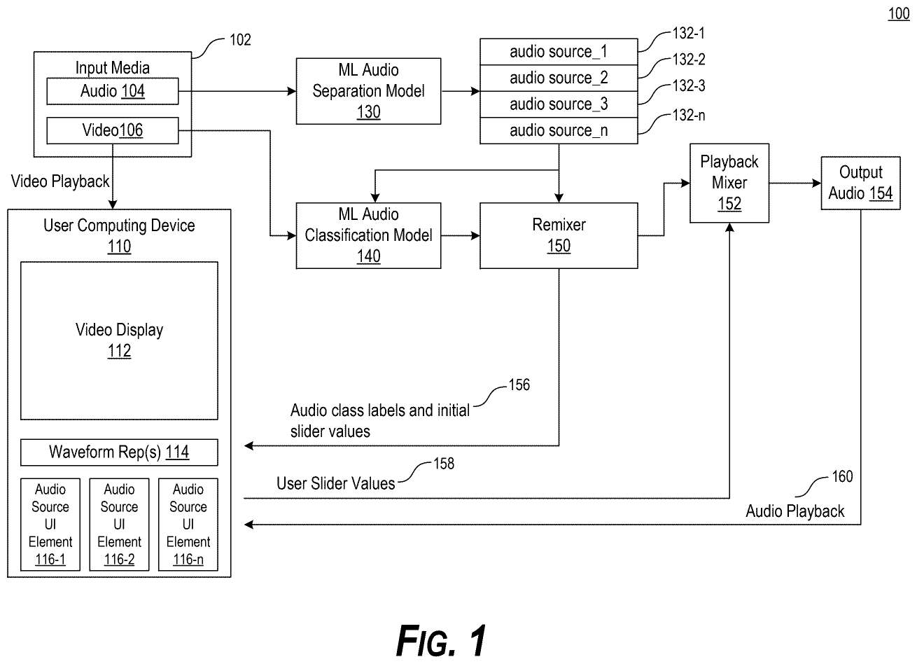

FIG. 1 is a block diagram depicting an example computing environment 100 including a machine-learned system for separating sounds from a media input and providing an interface for manipulating distinct sounds in the media input. In accordance with an example embodiments, the separation of sounds from a media input can be performed by converting the sound (e.g., audio data) from the media input into the short-time Fourier transform (STFT) domain so that the sound can be analyzed as a 2D image of time vs. frequency. Computing environment 100 can include a user computing device 110 that is configured to process input media to generate separated sound components that can be classified and individually controlled for playback.

User computing device 110 can implement a machine-learned audio separation model 140, machine-learned classification model 140, remixer 150, and playback mixer 152 to process input media 102 for audio playback 160. In some examples, computing environment 100 may be implemented as a client server computing environment, including one or more client computing devices implementing one or more components of environment 100 and one or more server computing systems implementing one or more components of environment 100. The computing systems implementing the computing environment can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a client computing device implementing a downstream application can be any suitable device, including, but not limited to, a smartphone, a tablet, a laptop, a desktop computer, or any other computer device that is configured such that it can allow a user to access remote computing devices over a network. The client computing devices can include one or more processor(s), memory, and a display as described in more detail hereinafter. The client computing devices can execute one or more client applications such as a web browser, email application, chat application, video conferencing application, word processing application or the like.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

User computing device 110 can obtain input media 102 for video playback on the user computing device. The input media can be generated by one or more sensors of the user computing device 110 such as one or more cameras or other image capture device and one or more microphones or other audio capture devices. In another example, the input media 102 can be received over a network from another computing device. The input media 102 can include audio 104 and video 106 that are temporally aligned. The audio 104 can include one or more audio tracks and video 106 can include one or more video tracks.

Audio data 104 is provided to machine-learned audio separation model 130. Audio separation model 130 processes the input audio to generate multiple audio tracks corresponding to individual sources of audio in the input audio 104. By way of example, the input audio 104 can include decoded original audio in a raw format (e.g., sample rate A, channel count B, 16 bit, bid-endian). The output audio can include a plurality of separated audio sources 132-1, 132-2, 132-3, . . . , 132-n (e.g., four) of audio in a raw format (e.g., sample rate A, channel count 1, 16 bit, big-endian).

The separated audio components or sources 132-1, 132-2, 132-3, . . . , 132-n are provided as inputs to machine-learned audio classification model 140. Audio classification model 140 also receives input video 106 as an input. The input video can include decoded original video in a raw format (e.g., frame rate C, frame size D, GPU buffer). Audio classification model 140 can generate an output including confidence scores (e.g., for 537 potential classes) for each audio source for each second or other duration of video. For example, the output can include one on-screen probability (e.g., one class) for each audio source for every 5 seconds or other duration of video. A classification post-processing module can receive the classification confidence scores and the one on-screen probability for each source and generate an output including labels for each audio track and initial slider values (e.g., output volume levels) for each track.

Remixer 150 receives as inputs the separated audio components or sources 132-1, 132-2, 132-3, . . . , 132-n in their raw format (e.g., sample rate A, channel count 1, 16 bit, big-endian) from the audio separation model 130, the classification results from the classification model 140, and the onscreen probability results from the classification model. Remixer 150 generates an output including the audio class labels and initial slider values (or other audio control values) to the user interface. The user computing device 110 includes a user interface having a video display 112 for rendering video 106, waveform representations 114 representing the individual audio sources, and audio source UI elements 116-1, 116-2, and 116-n corresponding to each of the audio sources 132-1, 132-2, . . . 132-n. Playback mixer 152 can receive the separated audio sources and user slider values 158 for each of the individual audio sources. For example, a user can manipulate an audio source UI element 116-1 to generate a slider value that controls the level of playback of a corresponding audio component 132-1. Playback mixer 152 can apply the user slider values to generate a mixed down output audio 154 in a raw format (e.g., sample rate A, channel count B, 16 bit, big-endian). The output audio 154 is then provided as audio playback 160 for the user interface.

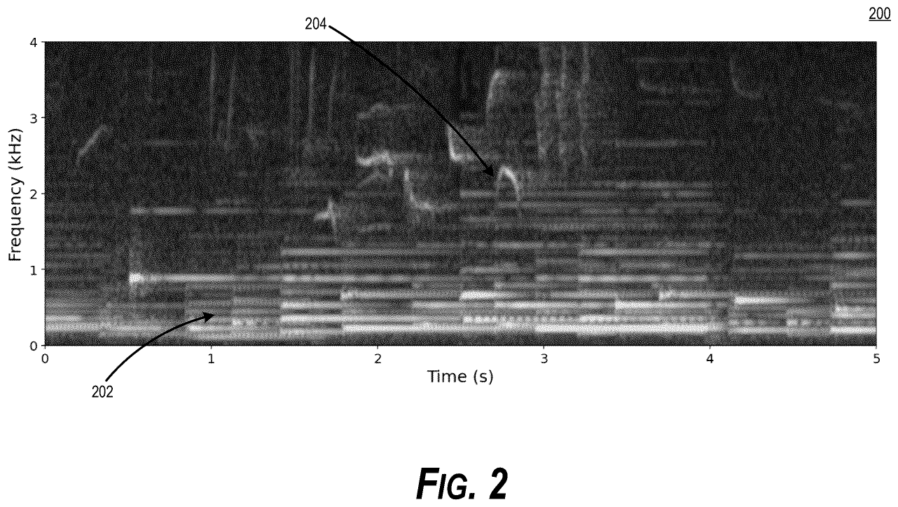

FIG. 2 is a diagram depicting an example sound input as a 2D image of time vs. frequency. In this representation, different classes of sound can be seen to appear with different characteristic image features. For example, the sound representation can be of a mix of piano music, chirping birds, and other background noise. The piano notes are identifiable as the straight horizontal image features 202 in the lower half of the image. The bird chirps appear as curved ridges image features 204.

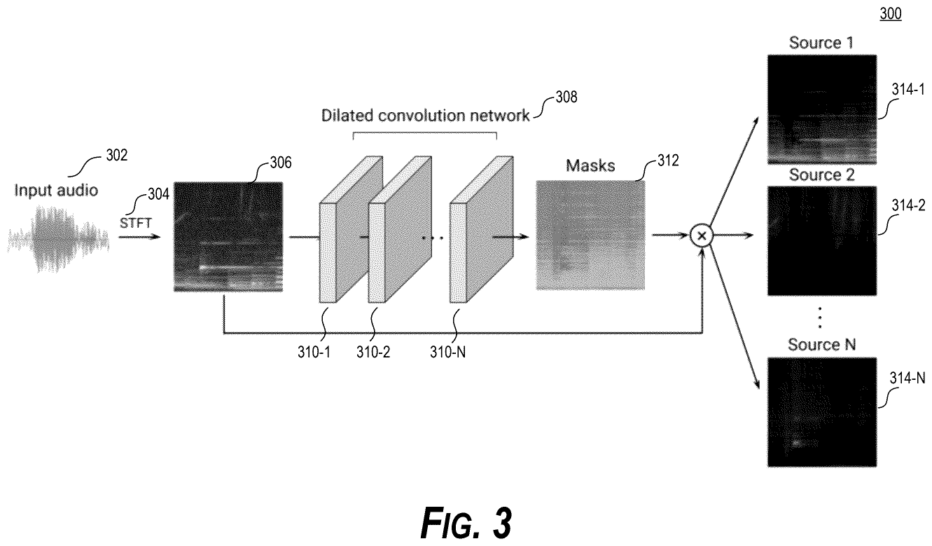

FIG. 3 is a block diagram of an example computing environment 300 including a machine-learned model that is configured to separate an audio input into distinct audio outputs associated with different sound sources. Computing environment 300 can be used to implement machine-learned audio separation model 130 in FIG. 1. In computing environment 300, a dilated convolution network 308 is applied to predict a set of soft masks 312 that partition a short-time Fourier transform (STFT) to isolate the constituent sound sources 314-1, 314-2, . . . , 314-n. The task can be comparable to natural image segmentation and matting. More particularly, input audio 302 is converted into the short-time Fourier transform domain or STFT, analyzing sound as a 2D image of time v. frequency. In the example representation of FIG. 2, different classes of sound can be seen to appear with different characteristic image features. Dilated convolution network 308 includes a plurality of convolutional layers 310-1, 310-2, . . . , 310-N that are configured to predict a set of soft masks 312 that can partition the STFT to isolate the constituent sound sources 314-1, 314-2, . . . , 314-N.

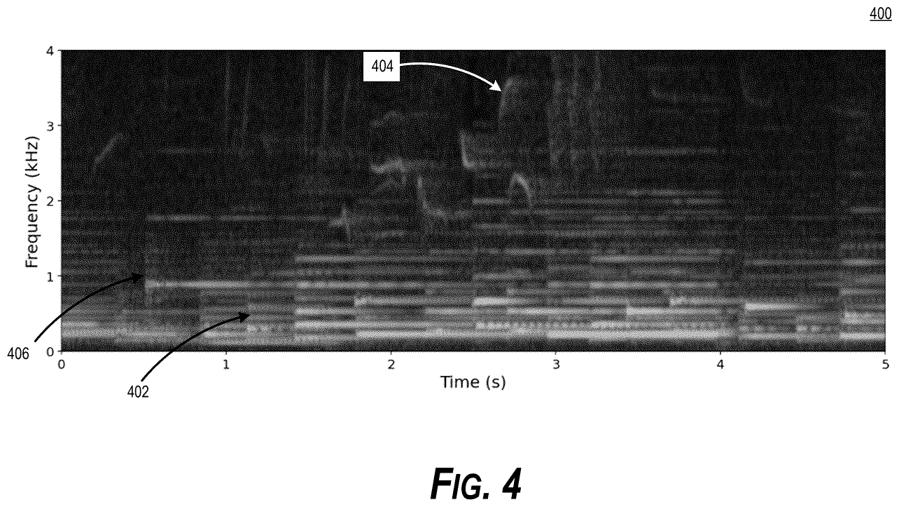

FIG. 4 is a diagram depicting masks predicted for the STFT of FIG. 2. In this example, a first set of image features 402 represent piano music, a second set of image features 404 represent bird chirps, and a third set of image features 406 represent noise. Each element is a value of [0, 1] representing a gain in that time-frequency cell. The masks can be pointwise multiplied with the input STFT to obtain an STFT estimate for each isolated sound source. This STFT-domain masking is comparable to filtering in the time domain with an FIR filter whose coefficients change dynamically over time.

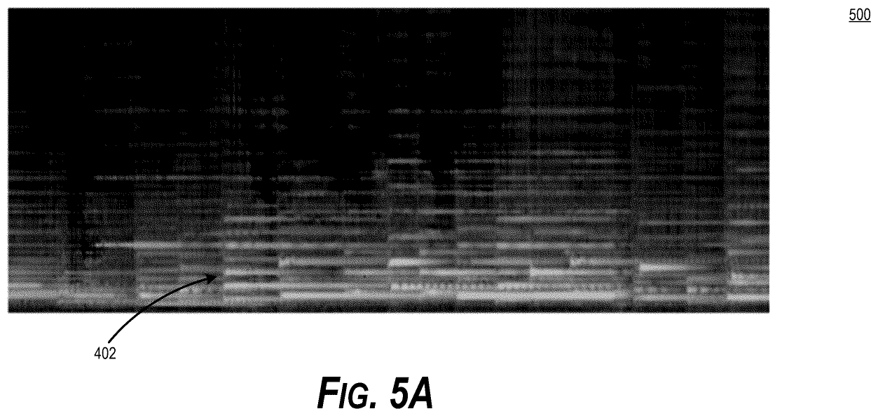

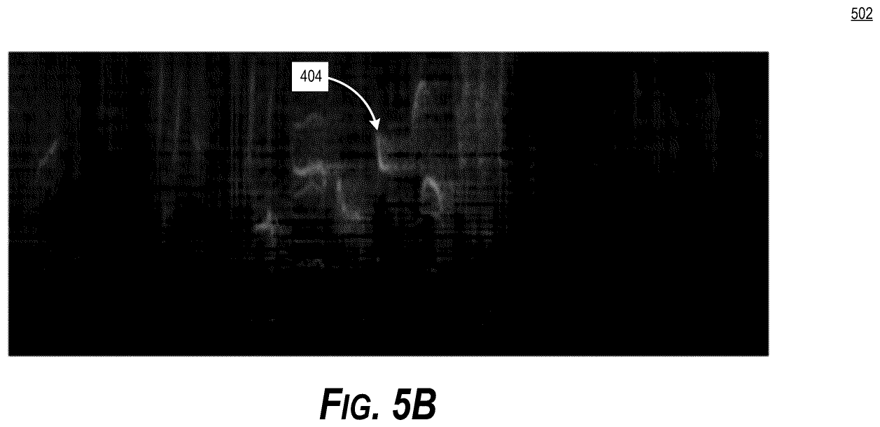

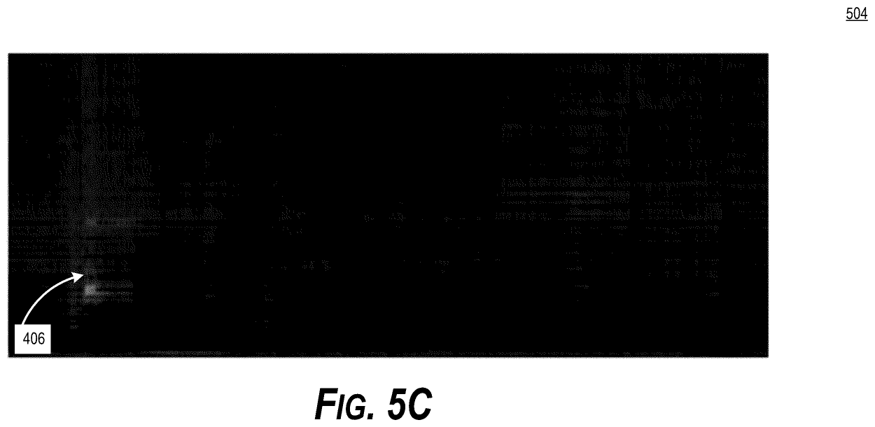

FIGS. 5A-5C are diagrams depicting the audio waveforms corresponding to piano music, bird chirps, and noise from the STFTs, respectively. FIG. 5A depicts image features 402 corresponding to piano music. FIG. 5B depicts image features 404 corresponding to bird chirps. FIG. 5C depicts image features 406 corresponding to noise.

The STFTs can be inverse-transformed to convert back to audio waveforms.

In accordance with example embodiments, the system can provide a user interface that is accessible and practically useful for user devices such as mobile devices. Conventionally, audio professionals use digital audio workstations (DAWs) to mix and edit audio. These interfaces tend to have extensive interfaces with many knobs and controls. In accordance with example embodiments, DAW editing is reimagined in a way that is accessible to the everyday user, not only audio professionals. A user interface is provided that is tenable on a mobile screen.

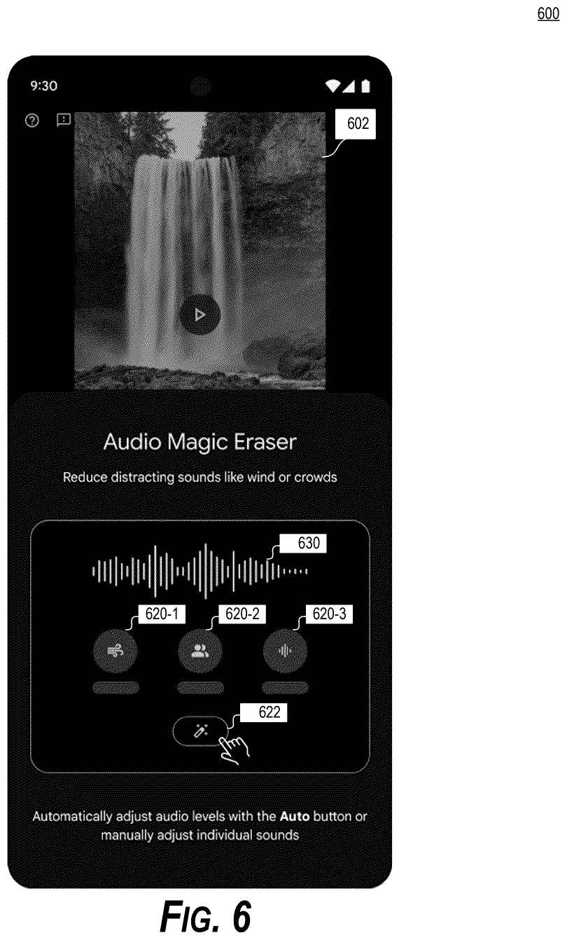

According to an example implementation, a user interface is provided that enables rebalancing source volumes. FIG. 6 is a block diagram depicting an example user interface 600. The user interface includes a display region 602 for displaying video of an input media during playback. For quick one-tap editing, an auto enhance button (user interface element) 622 is provided that adjusts all source volumes automatically. For more control, each sound source is displayed with a toggle button 620-1, 620-2, 620-3. Although three toggle buttons corresponding to three source sounds are depicted, any number of toggle buttons representing any number of source sounds may be included Pressing the toggle button 620-1, 620-2, 620-3 reveals a slider to adjust the volume for that source. Because it may be time consuming to listen through each separated track, the system provides a waveform visualization 630 to represent track contents at a glance as shown in FIG. 6. The audio can be processed to create a representation that approximates perceptual loudness and makes maximal use of available screen space. This representation can be updated dynamically as volume levels are edited, providing an intuitive, readable, and interactive representation of the content.

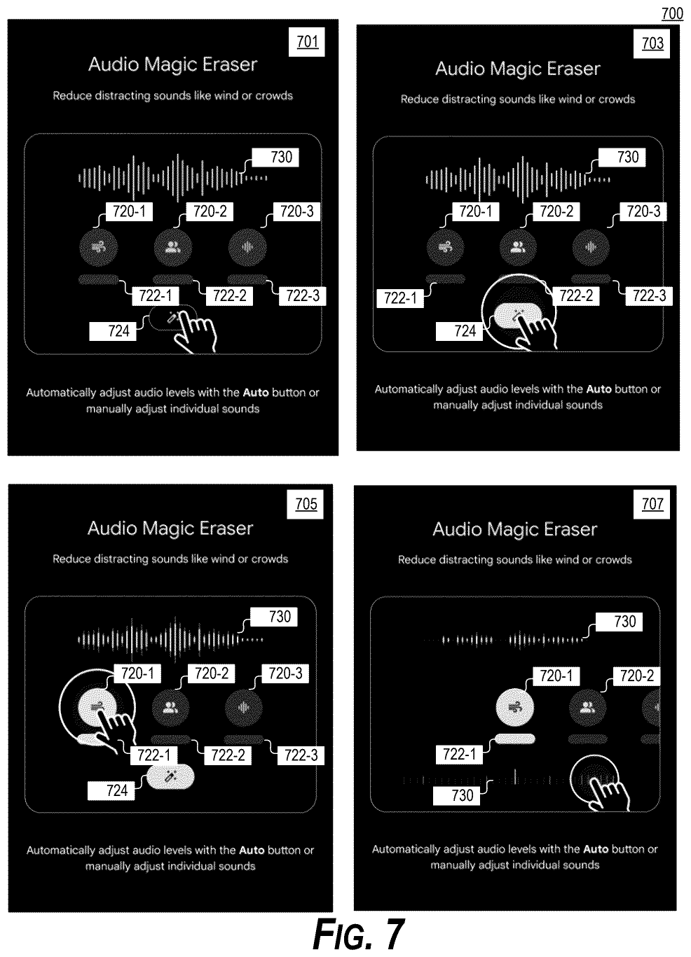

FIG. 7 depicts an example user interface 700 and an example user interaction with the user interface according to example embodiments of the present disclosure. A video or other media item can be selected and the system can automatically apply sound separation and classification analysis to the entire video. As shown at 701, the user interface 700 can be presented including a UI with toggle buttons or other UI elements 720-1-, 720-2, 720-3 representing separated audio sources. The UI elements can optionally include audio labels 722-1, 722-2, 722-3. Each separated audio source can include a user interface element that can be selected. As shown at 703, a UI element 724 such as auto enhance button can be provided that adjusts all source volumes automatically. When the “auto” UI element is selected, a recommended mix value for each track can be presented so that users do not have to manually set the values. As shown at 705, when a user interface element 720-1-, 720-2, 720-3 for a source is selected, the system can highlight the corresponding audio waveform. As shown at 707, users can change the volume between given thresholds using UI element 730 to change the mix of particular sources. A play UI element can be provided. When selected, the audio mix can be played back in a loop. Users can change the volume while playback occurs as well as listen to the adjusted mixture in real time.

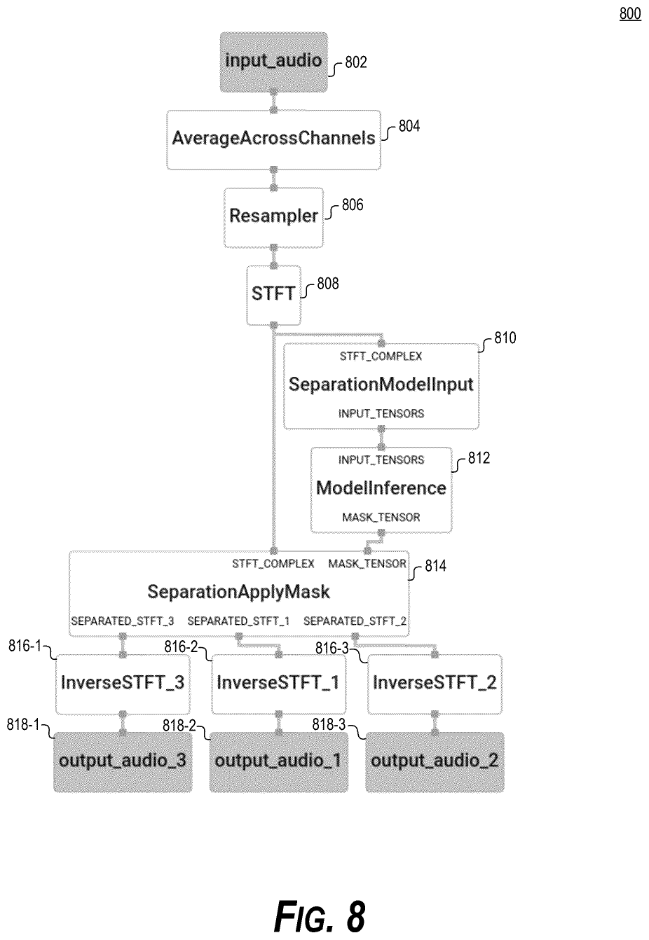

FIG. 8 is a block diagram depicting an example computing environment including a computing pipeline framework (e.g., MediaPipe) graph in accordance with example embodiments of the present disclosure. The example graph processes the audio separation (3 separated sources) task described in the previous section. Each modular processing unit can be scoped within a calculator (e.g,. MediaPipe calculator). For example units like audio digital signal processing (DSP) such as STFT mentioned above can be scoped. Additionally, media processing, data transformations across a wide variety of devices and platforms, as well as model inference can be scoped within a calculator. Such a technique enables putting all the operations in a directed graph and allowing the framework graph executor to schedule the execution with an order that maximizes the device compute and capabilities.

Input audio 802 can be obtained. The input audio can be averaged across the audio channels at 804. The averaged audio can be resampled at 806 to generate a short-time Fourier transform (STFT) at 808. The STFT computed at 808 can be provided an audio classification model input at 810. The audio classification model can generate input tensors from the input audio. The input tensors can be provided as input for audio classification model inference at 812. The audio classification model can generate a mask tensor for each audio source. The mask tensor(s) can be provided as an input along with the the STFT to apply the mask(s) for audio separation at 814. At 814, a separated STFT for each audio source can be computed as provided as an output. Each separated STFT representing a separated audio source can undergo an inverse short-time Fourier transform at 816-1, 816-2, 816-3. The inverse STFT of each separated sound source is used to generate an output audio of a separated sound source at 818-1, 818-2, 818-3.

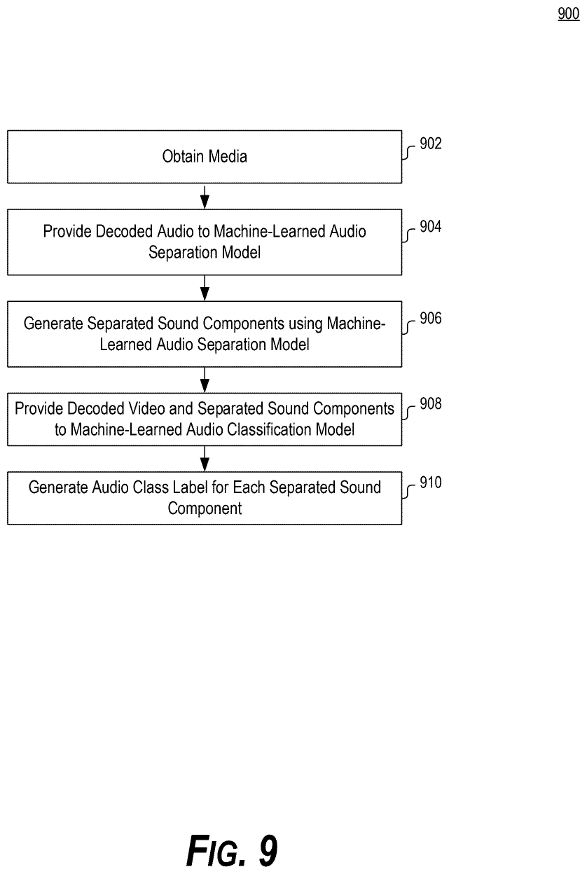

FIG. 9 is a flow chart diagram illustrating an example method 900 for separating and classifying sounds associated with different sources in a media input according to example implementations of aspects of the present disclosure. One or more portion(s) of example method 900 and the other methods described herein can be implemented by a computing system that includes one or more computing devices such as, for example, computing systems described with reference to the other figures. Each respective portion of the example methods can be performed by any (or any combination) of one or more computing devices. Moreover, one or more portion(s) of the example methods can be implemented on the hardware components of the device(s) described herein, for example, to generate separated sound sources from input audio. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and is not meant to be limiting. One or more portions of the example methods can be performed additionally, or alternatively, by other systems.

At 902, example method 900 can include obtaining media input including audio and video. The media can include one or more audio components and one or more video components. The components can be temporally aligned such that there is a one-to-one mapping between each audio component and each video component. The media can be obtained using one or more sensors of a device. In another example, the media can be obtained from a media source such as a media library or by user selection of a video, video frame, video track, etc. at 902.

The audio data can be decoded prior to sound separation. Global mode processing can be implemented to decode all of the audio data first and before passing the data to the sound separation model at once. This can address issues caused by streaming mode processing.

To speed up the video decoding time, a keyframe only decoding method can be implemented, which uses the seek operation to locate a keyframe that is nearest to a required video frame. The keyframe can then be decoded for use. The seek operation and the keyframe decoding together takes much less time than decoding all of the frames from the beginning until reaching a particular frame. A nearest neighbor interpolation method can be used to make sure the keyframe rate matches an expected frame rate (e.g., 1 FPS).

At 904, example method 900 can include providing decoded audio from the media to a machine-learned audio separation model. The machine-learned audio separation model can include one or more machine-learned audio separation models. The model(s) can be configured to generate a separated audio output for each audio source present in the media input.

At 906, example method 900 can include generating a plurality of separated audio components from the decoded audio using the machine-learned audio separation model.

At 908, example method 900 can include providing decoded video from the media and the plurality of separated audio components to a machine-learned audio classification model. The machine-learned audio classification model can include one or more machine-learned audio classification models. The model(s) can be configured to generate an audio class label for each separated sound source.

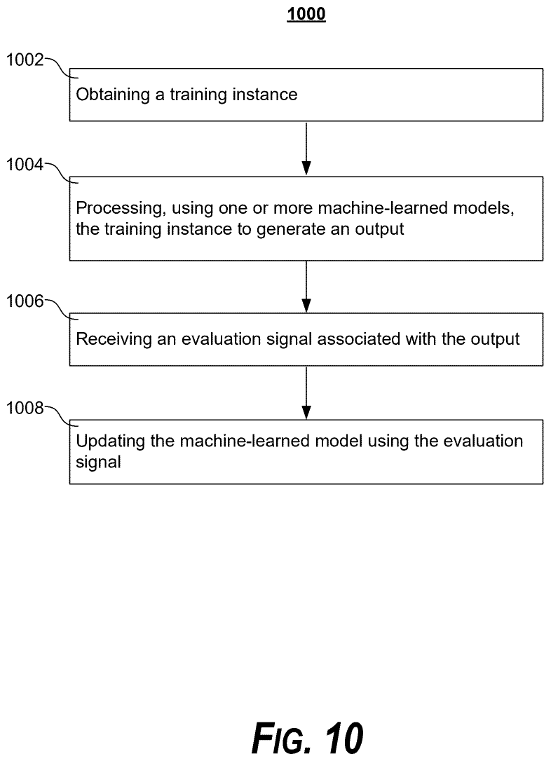

At 910, example method 900 can include generating an audio class label for each of the plurality of separated audio components using the machine-learned audio classification model. FIG. 10 depicts a flowchart of a method 1000 for training one or more machine-learned models according to aspects of the present disclosure. For instance, an example machine-learned model can include a machine-learned audio separation model or a machine-learned audio classification model.

One or more portion(s) of example method 1000 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

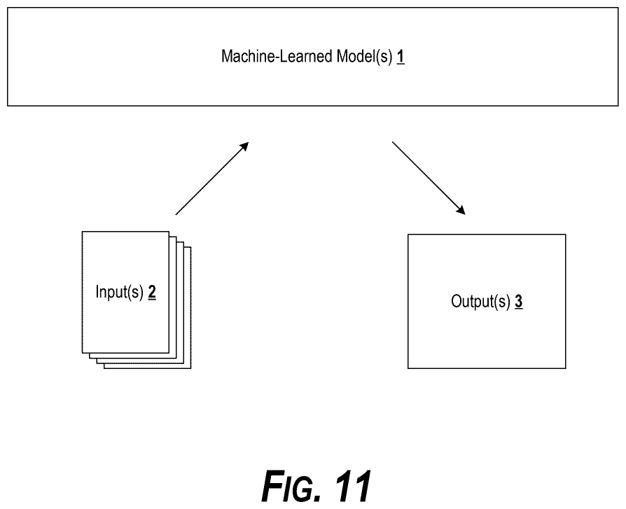

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

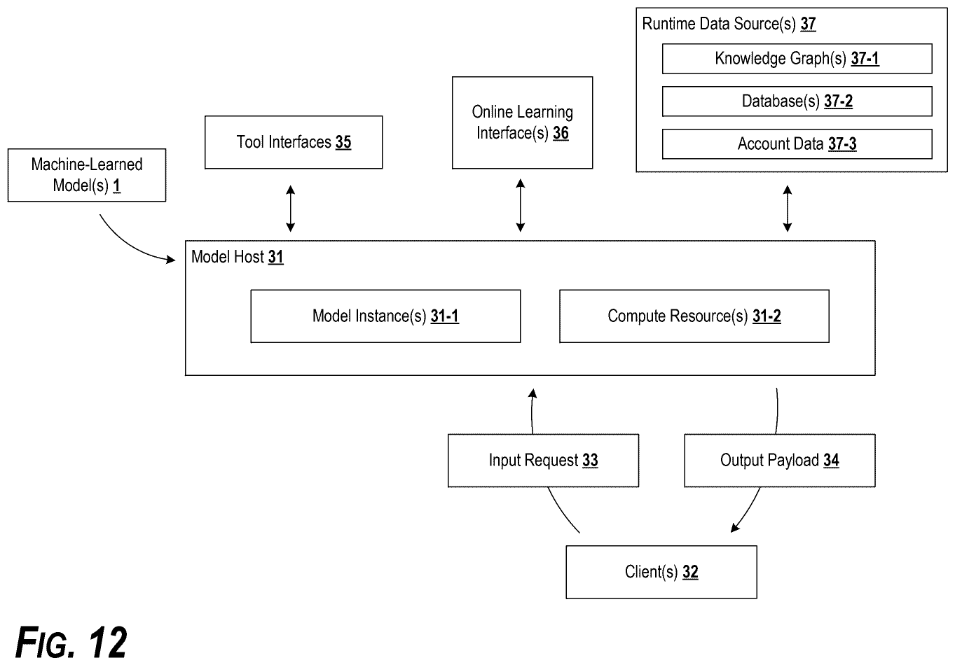

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

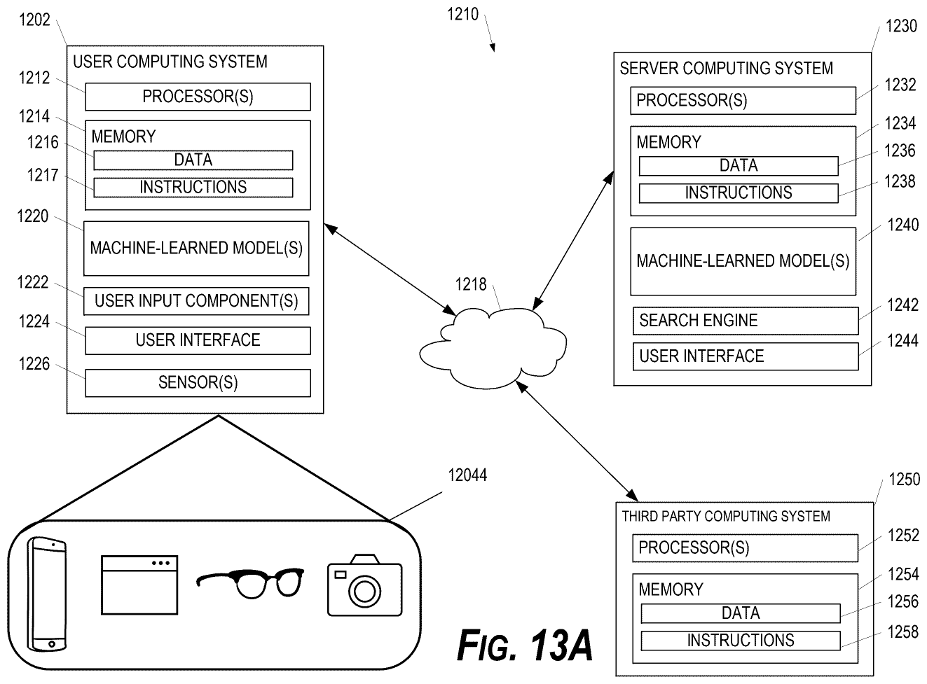

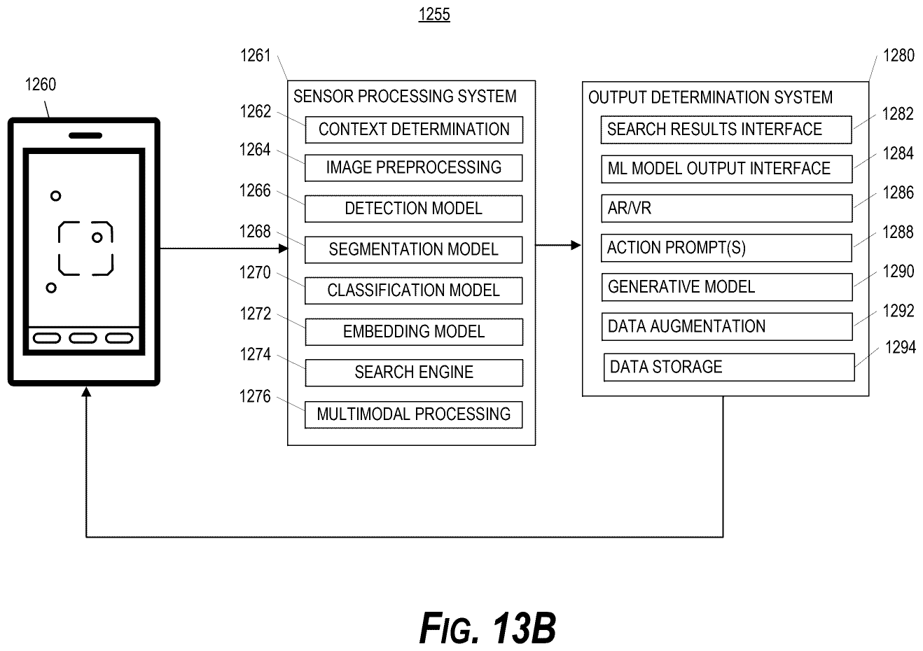

FIG. 13A is a block diagram depicting an example computing system that can implement a machine-learned audio separation and classification system according to example embodiments of the present disclosure. The system 1210 includes a user computing system 1202, a server computing system 1230, and/or a third computing system 50 that are communicatively coupled over a network 1218.

The machine-learned audio separation and classification system can be implemented entirely by a user computing system 1202 in example embodiments. In some examples the system can be implemented using additional or different computing systems.

The user computing system 1202 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1202 includes one or more processors 1212 and a memory 1214. The one or more processors 1212 can be any suitable processing device (e.g., a processor core, a microprocessor, an ASIC, a FPGA, a controller, a microcontroller, etc.) and can be one processor or a plurality of processors that are operatively connected. The memory 1214 can include one or more non-transitory computer-readable storage mediums, such as RAM, ROM, EEPROM, EPROM, flash memory devices, magnetic disks, etc., and combinations thereof. The memory 1214 can store data 1216 and instructions 1217 which are executed by the processor 1212 to cause the user computing system 1202 to perform operations.

In some implementations, the user computing system 1202 can store or include one or more machine-learned models 1220. For example, the machine-learned models 1220 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1220 can be received from the server computing system 1230 over network 1218, stored in the user computing device memory 1214, and then used or otherwise implemented by the one or more processors 1212. In some implementations, the user computing system 1202 can implement multiple parallel instances of a single machine-learned model 1220 (e.g., to perform parallel machine-learned model processing across multiple instances of input data and/or detected features).

More particularly, the one or more machine-learned models 1220 may include one or more audio separation models, audio classification models, detection models, one or more classification models, one or more segmentation models, one or more augmentation models, one or more generative models, one or more natural language processing models, one or more optical character recognition models, and/or one or more other machine-learned models. The one or more machine-learned models 1220 can include one or more transformer models. The one or more machine-learned models 1220 may include one or more neural radiance field models, one or more diffusion models, and/or one or more autoregressive language models.

The one or more machine-learned models 1220 may be utilized to detect one or more object features. The detected object features may be classified and/or embedded. The classification and/or the embedding may then be utilized to manipulate separated sounds from media. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1220 can process image data, text data, audio data, and/or latent encoding data to generate output data that can include image data, text data, audio data, and/or latent encoding data. The one or more machine-learned models 1220 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 40 can be included in or otherwise stored and implemented by the server computing system 30 that communicates with the user computing system 1202 according to a client-server relationship. For example, the machine-learned models 1240 can be implemented by the server computing system 1230 as a portion of a web service (e.g., a viewfinder service, a visual search service, an image processing service, an ambient computing service, and/or an overlay application service). Thus, one or more models 1220 can be stored and implemented at the user computing system 1202 and/or one or more models 1240 can be stored and implemented at the server computing system 1230.

The user computing system 1202 can also include one or more user input components 1222 that receive user input. For example, the user input component 1222 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 1224, which may be associated with one or more applications. The one or more user interfaces 1224 can be configured to receive inputs and/or provide data for display (e.g., image data, text data, audio data, one or more user interface elements, an augmented-reality experience, a virtual reality experience, and/or other data for display). The user interfaces 1224 may be associated with one or more other computing systems (e.g., server computing system 1230 and/or third party computing system 1250). The user interfaces 1224 can include a viewfinder interface, a search interface, a generative model interface, a social media interface, and/or a media content gallery interface.

The user computing system 1202 may include and/or receive data from one or more sensors 1226. The one or more sensors 1226 may be housed in a housing component that houses the one or more processors 1212, the memory 1214, and/or one or more hardware components, which may store, and/or cause to perform, one or more software packets. The one or more sensors 1226 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 1202 may include, and/or pe part of, a user computing device 1204. The user computing device 1204 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 4. For example, a camera of a smartphone may be utilized to capture image data descriptive of the environment, and/or an overlay application of the user computing device 4 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 1230 includes one or more processors 1232 and a memory 1234. The one or more processors 1232 can be any suitable processing device (e.g., a processor core, a microprocessor, an ASIC, a FPGA, a controller, a microcontroller, etc.) and can be one processor or a plurality of processors that are operatively connected. The memory 1234 can include one or more non-transitory computer-readable storage mediums, such as RAM, ROM, EEPROM, EPROM, flash memory devices, magnetic disks, etc., and combinations thereof. The memory 1234 can store data 1236 and instructions 1238 which are executed by the processor 1232 to cause the server computing system 1230 to perform operations.

In some implementations, the server computing system 1230 includes or is otherwise implemented by one or more server computing devices. In instances in which the server computing system 30 includes plural server computing devices, such server computing devices can operate according to sequential computing architectures, parallel computing architectures, or some combination thereof.

As described above, the server computing system 1230 can store or otherwise include one or more machine-learned models 1240. For example, the models 1240 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1240 are discussed with reference to FIG. 5B.

The server computing system 1230 may store and/or provide one or more user interfaces 1244 for obtaining input data and/or providing output data to one or more users. The one or more user interfaces 1244 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1202 and/or the server computing system 1230 can train the models 1220 and/or 1240 via interaction with the third party computing system 1250 that is communicatively coupled over the network 1218. The third party computing system 1250 can be separate from the server computing system 1230 or can be a portion of the server computing system 30. Alternatively and/or additionally, the third party computing system 1250 may be associated with one or more web resources, one or more web platforms, one or more other users, and/or one or more contexts.

The third party computing system 1250 can include one or more processors 1252 and a memory 1254. The one or more processors 1252 can be any suitable processing device (e.g., a processor core, a microprocessor, an ASIC, a FPGA, a controller, a microcontroller, etc.) and can be one processor or a plurality of processors that are operatively connected. The memory 1254 can include one or more non-transitory computer-readable storage mediums, such as RAM, ROM, EEPROM, EPROM, flash memory devices, magnetic disks, etc., and combinations thereof. The memory 1254 can store data 1256 and instructions 1258 which are executed by the processor 1252 to cause the third party computing system 1250 to perform operations. In some implementations, the third party computing system 1250 includes or is otherwise implemented by one or more server computing devices.

The network 1218 can be any type of communications network, such as a local area network (e.g., intranet), wide area network (e.g., Internet), or some combination thereof and can include any number of wired or wireless links. In general, communication over the network 1218 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1202 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 10.

The central intelligence layer can communicate with a central device data layer. The central device data layer can be a centralized repository of data for the computing system. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 13B is a block diagram depicting an example computing system that performs sound separation and classification according to example embodiments of the present disclosure. In particular, the example computing system 1250 can include one or more computing devices 1260 that can be utilized to obtain, and/or generate, one or more datasets that can be processed by a sensor processing system 1261 and/or an output determination system 1280 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 1260 (e.g., one or more sensors in the computing device 1260). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 1260 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 1261. The sensor processing system 1261 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 1262, which may determine a context associated with one or more content items. The context determination block 1262 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 1261 may include an image preprocessing block 1264. The image preprocessing block 1264 may be utilized to adjust one or more values of an obtained and/or received image to prepare the image to be processed by one or more machine-learned models and/or one or more search engines 1274. The image preprocessing block 1264 may resize the image, adjust saturation values, adjust resolution, strip and/or add metadata, and/or perform one or more other operations.

In some implementations, the sensor processing system 1261 can include one or more machine-learned models, which may include a detection model 1266, a segmentation model 1268, a classification model 1270, an embedding model 1272, and/or one or more other machine-learned models. For example, the sensor processing system 1261 may include one or more detection models 1266 that can be utilized to detect particular features in the processed dataset. In particular, one or more images can be processed with the one or more detection models 1266 to generate one or more bounding boxes associated with detected features in the one or more images.

Additionally and/or alternatively, one or more segmentation models 1268 can be utilized to segment one or more portions of the dataset from the one or more datasets. For example, the one or more segmentation models 1268 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 1270 can be utilized to process image data, text data, audio data, latent encoding data, multimodal data, and/or other data to generate one or more classifications. The one or more classification models 1270 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 1272 to generate one or more embeddings. For example, one or more images can be processed with the one or more embedding models 1272 to generate one or more image embeddings in an embedding space. The one or more image embeddings may be associated with one or more image features of the one or more images. In some implementations, the one or more embedding models 1272 may be configured to process multimodal data to generate multimodal embeddings. The one or more embeddings can be utilized for classification, search, and/or learning embedding space distributions.

The sensor processing system 1261 may include one or more search engines 1274 that can be utilized to perform one or more searches. The one or more search engines 1274 may crawl one or more databases (e.g., one or more local databases, one or more global databases, one or more private databases, one or more public databases, one or more specialized databases, and/or one or more general databases) to determine one or more search results. The one or more search engines 1274 may perform feature matching, text based search, embedding based search (e.g., k-nearest neighbor search), metadata based search, multimodal search, web resource search, image search, text search, and/or application search.

Additionally and/or alternatively, the sensor processing system 61 may include one or more multimodal processing blocks 1276, which can be utilized to aid in the processing of multimodal data. The one or more multimodal processing blocks 1276 may include generating a multimodal query and/or a multimodal embedding to be processed by one or more machine-learned models and/or one or more search engines 1274.

The output(s) of the sensor processing system 1261 can then be processed with an output determination system 1280 to determine one or more outputs to provide to a user. The output determination system 1280 may include heuristic based determinations, machine-learned model based determinations, user selection based determinations, and/or context based determinations.

The output determination system 1280 may determine how and/or where to provide the one or more search results in a search results interface 1282. Additionally and/or alternatively, the output determination system 1280 may determine how and/or where to provide the one or more machine-learned model outputs in a machine-learned model output interface 1284. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 1261 may be utilized to generate and/or provide an augmented-reality experience and/or a virtual-reality experience 1286. For example, the one or more obtained datasets may be processed to generate one or more augmented-reality rendering assets and/or one or more virtual-reality rendering assets, which can then be utilized to provide an augmented-reality experience and/or a virtual-reality experience 1286 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 1288 may be determined based on the output(s) of the sensor processing system 1261. For example, a search prompt, a purchase prompt, a generate prompt, a reservation prompt, a call prompt, a redirect prompt, and/or one or more other prompts may be determined to be associated with the output(s) of the sensor processing system 1261. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 1261 may be processed with one or more generative models 1290 to generate a model-generated content item that can then be provided to a user. The generation may be prompted based on a user selection and/or may be automatically performed (e.g., automatically performed based on one or more conditions, which may be associated with a threshold amount of search results not being identified).

The output determination system 1280 may process the one or more datasets and/or the output(s) of the sensor processing system 1261 with a data augmentation block 1292 to generate augmented data. For example, one or more images can be processed with the data augmentation block 1292 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 1261 may be stored based on a data storage block 1294 determination.

The output(s) of the output determination system 1280 can then be provided to a user via one or more output components of the user computing device 1260. For example, one or more user interface elements associated with the one or more outputs can be provided for display via a visual display of the user computing device 1260.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method implemented by one or more processors, the method comprising:
obtaining media including audio and video;
providing decoded audio from the media to a machine-learned audio separation model;
generating a plurality of separated sound components from the decoded audio using the machine-learned audio separation model;
providing decoded video from the media and the plurality of separated sound components to a machine-learned audio classification model; and
generating a class label for each of the plurality of separated sound components using the machine-learned audio classification model.

2. The computer-implemented method of claim 1, wherein:
the media includes a plurality of frames of audio and video;
the method further comprises performing keyframe-only decoding of the media to generate the decoded video, the decoded video corresponding to less than all of the plurality of frames of video from the media.

3. The computer-implemented method of claim 2, wherein performing keyframe-only decoding comprises:
performing seek operations to locate keyframes nearest to required video frames; and
decoding the keyframes nearest to the required video frames.

4. The computer-implemented method of claim 1, further comprising:
generating a graphical user interface including the class label and a user interface element for each of the plurality of separated sound components, wherein the user interface element enables user modification of a corresponding separated sound component.

5. The computer-implemented method of claim 1, wherein:
the machine-learned audio separation model is executed by a graphical processing unit; and
the machine-learned audio classification model is executed by a tensor processing unit.

6. The computer-implemented method of claim 1, further comprising:
decoding all audio data from the media prior to passing the decoded audio to the machine-learned audio separation model.

7. The computer-implemented method of claim 1, further comprising:
decoding video from the media in parallel with generating the plurality of separated sound components from the decoded audio using the machine-learned audio separation model.

8. The computer-implemented method of claim 1, further comprising:
decoding video from the media in parallel with decoding audio from the media.

9. The computer-implemented method of claim 1, wherein the media includes a video file.

10. The computer-implemented method of claim 1, wherein:
each separated sound component corresponds to a distinct source of audio in the media.

11. A system, comprising:
one or more processors; and
one or more computer-readable storage media that store instructions that, when executed by the one or more processors, cause the one or more processors to perform operations, the operations comprising:
obtaining media including audio and video;
providing decoded audio from the media to a machine-learned audio separation model;
generating a plurality of separated sound components from the decoded audio using the machine-learned audio separation model;
providing decoded video from the media and the plurality of separated sound components to a machine-learned audio classification model; and
generating a class label for each of the plurality of separated sound components using the machine-learned audio classification model.

12. The system of claim 11, wherein:
the media includes a plurality of frames of audio and video;
the operations further comprise performing keyframe-only decoding of the media to generate the decoded video, the decoded video corresponding to less than all of the plurality of frames of video from the media.

13. The system of claim 12, wherein performing keyframe-only decoding comprises:
performing seek operations to locate keyframes nearest to required video frames; and
decoding the keyframes nearest to the required video frames.

14. The system of claim 11, further comprising:
generating a graphical user interface including the class label and a user interface element for each of the plurality of separated sound components, wherein the user interface element enables user modification of a corresponding separated sound component.

15. The system of claim 11, wherein:
the machine-learned audio separation model is executed by a graphical processing unit; and
the machine-learned audio classification model is executed by a tensor processing unit.

16. The system of claim 11, further comprising:
decoding all audio data from the media prior to passing the decoded audio to the machine-learned audio separation model.

17. The system of claim 11, further comprising:
decoding video from the media in parallel with generating the plurality of separated sound components from the decoded audio using the machine-learned audio separation model.

18. The system of claim 11, further comprising:
decoding video from the media in parallel with decoding audio from the media.

19. The system of claim 11, wherein the media includes a video file.

20. A computer-implemented method implemented by one or more processors, the method comprising:
obtaining media including a plurality of frames of audio and video;
providing decoded audio from the media to a machine-learned audio separation model;
generating a plurality of separated sound components from the decoded audio using the machine-learned audio separation model;
performing keyframe-only decoding of the media to generate decoded video corresponding to less than all of the plurality of frames of video from the media;
providing the decoded video and the plurality of separated sound components to a machine-learned audio classification model;
generating an audio class label for each of the plurality of separated sound components using the machine-learned audio separation model; and
generating a graphical user interface including the audio class label and a user interface element for each of the plurality of separated sound components, wherein the user interface element enables user modification of a corresponding separated sound component.
